(19) United States
(12) Patent Application Publication
(10) Pub. No.: US 2003/0182234 A1
(43) Pub. Date: Sep. 25, 2003

(54) Method and system for document presentment between generic publishers and generic subscribers

(76) Inventor: John Degroot, Toronto (CA)

Correspondence Address: WILLIAM B. PATTERSON, MOSER, PATTERSON & SHERIDAN, L.L.P., Suite 1500, 3040 Post Oak Blvd., Houston, TX, 77056, US

(21) Appl. No.: 10/105,085

(22) Filed: Mar. 22, 2002

(51) Int. Cl. G06F 17/60

(52) U.S. Cl. 705/51

(57) ABSTRACT

A method and system for electronic document presentment over Internet are provided. The presentment system mediates between generic publishers and generic subscribers located remotely through software accessed over the Internet. The system and method allow for publishers and subscribers to be categorized according to their relationship to each other. The system is not biased in favour of any one type of information or type of document (e.g. electronic bills), but rather leaves the relationship and the presentment business rules up to the publisher of the information. The system allows authentication of subscribers to ensure secure access and defined levels of interactivity with the presented information. The method and system support subscriber categories other than accountholders, such as financial advisors.

### FIELD OF THE INVENTION

The present invention relates to methods and systems of communicating and providing access to information over distributed networks. In particular, the invention relates to methods and systems of communicating and providing access to financial information over the Internet.

### BACKGROUND OF THE INVENTION AND PRIOR ART

Information exchange between parties involved in a business relationship is an ongoing requirement of that relationship. Prior to the widespread availability of electronic data processing machines and networks, this information exchange was conducted using physical media and delivery. For example, bills were rendered to paper and delivered by a national postal system or a private courier. Subsequent to delivery, the two parties each managed such information independently. For example, in the case of consumer billing, the customer received the bill at a post office box or at their home and had the option of filing the paper, discarding the paper or, in recent times, manually entering the information into a personal financial management system. The billing entity also managed the bill for a period of time as prescribed by statute or terms of agreement. The archival methods employed by billers included physical copies, microfiche, or, in more recent times, electronic images. These archived copies could be retrieved on demand for reasons of customer support or dispute resolution.

There are a number of disadvantages in these paper-based methods. The biller incurs the cost of producing and delivering the bill and of archiving copies of the bill. The customer must manage a significant amount of paper and is solely responsible for transcribing that information to electronic format, if he/she elects to do so. Once rendered to a physical medium, the information cannot be easily rendered in an alternate format or used for a different purpose without the use of costly and potentially inaccurate image scanning technology. A trivial example is when a utility consumer must read the amount due from a bill and enter it manually into an electronic payment mechanism such as an automated banking machine or telephone banking IVR (Interactive Voice Response).

More recently, attempts have been made to replace paper-based information delivery methods with their electronic counterparts. One category that has received considerable attention is consumer electronic bill presentment and payment (EBPP). Numerous methods have been disclosed that allow consumer bill producers to deliver bills over the Internet or private networks (e.g. U.S. Pat. No. 5,699,528), to consolidate bills in one location for the benefit of the customer (e.g. U.S. Pat. No. 6,035,285), that link the presentment of the bill with pre-existing electronic payment systems (e.g. U.S. Pat. No. 5,832,460), and that describe a central facility where multiple bills are consolidated for both presentment and payment (e.g. U.S. Pat. No. 5,978,780). Also disclosed are a number of “business-to-business” systems that allow documents such as invoices to be managed and delivered in the same manner.

While these methods have addressed some issues such as cost and consumer convenience, they have failed to address others. In particular, the information exchange between corporate and other organizational entities is varied and complex.

For example, some entities entered the electronic presentment marketplace by implementing what is generally known as B2C (business-to-consumer) billing, which in some cases proved difficult to migrate to B2B (business-to-business) requirements, including, alternate document types such as statements and different types of customer such as businesses. A common problem encountered in such a migration is the fact that many systems employed to provide B2C service are unable to address the needs of B2B. This was primarily due to the fact that the systems were designed for B2C only. There are different needs in B2B presentment than B2C. Unlike B2C applications, B2B applications must be capable of representing two-way relationships (i.e. presentment might be back-and-forth between the companies involved), variable levels of access (depending on role and identity of the subscriber involved), and routing of information among and between departments within an organization. Similar issues arise when a larger entity contains business units that address disparate market sectors but wishes to maximize the use of a common infrastructure for cost or other purposes. The methods disclosed in this technical field have addressed common infrastructure only at the level of communication networks and computer equipment.

Many of the prior art systems are specialized to one particular type of document (i.e. bills, statements, or invoices) and offload the responsibility for multiple point connectivity to the participants whose needs they are attempting to address. One such case is B2C EBPP, where the onus is often on consumers to access multiple Internet sites to view and pay their bills. This is true for consolidator systems as well, since many such implementations are the only service employed by the biller, again forcing the consumer to go to the information as opposed to the infrastructure finding and retrieving the information for the consumer. The same issue arises for the billers who are often forced to engage multiple providers if they wish to reach all of their customers. If they elect to do so, they must incur the inevitable duplicate cost and deal with dissimilar operating procedures.

Accordingly, the prior art methods and systems have not addressed the need for a general method and system for document presentment between publishers (i.e. parties providing information) and subscribers (i.e. parties receiving information) generally, without regard to the type of document or the pre-existing relationship between publisher and subscriber.

### SUMMARY OF THE INVENTION

It is an object of the invention to generalize the management of information in financial form which is to be published externally of the entity generating it, and is to be retrieved or accessed externally from that entity by the addressee, over the Internet or another distributed network. Such information includes, but is not limited to, business transaction documents such as bills or invoices, periodic statements of account, personalized reports such as municipal land surveys, and broadcast reports such as prospectuses. The system is defined as an infrastructure upon which different business applications may be deployed without having to “re-invent the wheel”.

Other objects of the invention are as follows:

To provide an infrastructure consisting of generic entities, processes and operating rules that addresses the needs of external information management and delivery that are common to many electronic business applications.

To be extensible so that when a new application is deployed, the business definitions and processes can be defined by renaming or adding to the core generic entities defined by the method.

To migrate connectivity and information delivery complexity from the business participants to the infrastructure.

To provide maximum deployment flexibility that exploits the ubiquitous nature of modern network services and addresses a plurality of business information delivery models.

To allow information to be presented in multiple formats and in multiple aggregations such that the new renditions can be built without modifying the original information.

To maximize the capability of participants to manage themselves.

Entities, herein collectively referred to as service providers, are responsible for managing and delivering financial information and also form the basis of the deployment flexibility that is a primary goal of the invention. Persons and organizations contact service providers for the purpose of accessing the information management infrastructure through a process called registration. Once registered, a person or organization is defined as a publisher or a subscriber; where a publisher produces information, and a subscriber receives information. A hierarchical identifier is assigned consisting of a subscriber number and an account number in order to represent the business relationship that already exists between a publisher and a subscriber. Documents are loaded to the service provider by the publisher and made available to the subscriber in a process known as presentment. Preferably, multiple documents to be presented as a single unit, and language-, format-, and date-sensitive templates may be defined by the publisher.

According to a first aspect of the invention, a system is provided for electronic document presentment over Internet by at least one generic publisher for at least one generic subscriber. “Generic” as used herein refers to the fact that the system treats publishers as providers of information, and subscribers as receivers of information, regardless of the type of information, and the pre-existing relationship between the publisher and the subscriber. The system comprises an interface, a processor and a computer storage. The interface receives financial information from a publisher for publication as a document, and allows access to the document by a subscriber. (The subscriber may be located remotely from the publisher in communication over the Internet.) The processor runs software which publishes the information in the document and selectively allows retrieval of the document by the subscriber. The interface and the processor are in communication with each other. The computer storage stores the information received through the interface and, responsively to the processor, passes the information to the software for publication.

The software categorizes the subscriber and associates the subscriber with a security term, which determines the degree of access and interactivity with the information in the document. The security term is itself determined by the categorization of the subscriber's relationship to the information.

The “degree of access and interactivity” may include the ability of the subscriber to perform one or more of the following: viewing the document, printing the document, sending an electronic copy of the document, making an online payment relating to the information in the document, accessing an associated subscriber profile, submitting to the publisher an objection to the information in the document, communicating with the publisher in regard to the information in the document, and downloading the information to a financial management software application. Preferably, the service provider may provide additional subscriber functionality specific to the industry to which the document pertains, such as the ability to initiate a stock purchase from a brokerage account statement.

The software treats all subscribers generically, and contains no pre-programmed assumptions about the subscriber's relationship to the information requested, or the subscriber's relationship to any particular publisher, or number of publishers. However, in the process of registration and login, the subscriber will be able to identify those publishers with whom the subscriber has a relationship, and the subscriber will be able to provide some means of identification that will help the software to characterize and “categorize” this subscriber. For instance, a subscriber might provide an account number in the particular format accepted by a publisher, thereby categorizing the subscriber as an accountholder of the publisher.

“Financial information” as used herein is a particular type of external information, which can be associated with a financial transaction, a financial account, or an entity performing a financial transaction, or having an account. “Financial information” is not limited to numeric data, but may includes text, audio or visual information, or information in a data string.

The software may include a loader (a computer program) for receiving information from each publisher and publishing the information in the document in a format according to at least one template pre-defined by the publisher. The loader may automatically retrieve information from each publisher on a pre-defined periodic basis. The loader may include an aggregator for grouping documents associated with a subscriber.

Templates may be language-, format-, or date-sensitive. The information is preferably in XML format. The template is preferably an XSLT template.

The software may include a messenger for electronically notifying a subscriber of at least one document to be retrieved.

The subscriber may be an accountholder of the publisher. Alternatively, the subscriber may be a representative of an accountholder of the publisher (such as a financial advisor).

The documents themselves may have any number of real-world applications. For instance, they may be bills, statements, invoices, notices, or reports. For the purpose of the invention, a “document” can be any type of document that includes financial information, as defined herein.

The software preferably includes an authenticator for registering the subscriber and authenticating the identity of the subscriber before permitting the subscriber to access or interact with a document.

Various presentment models are supported. The presentment may take place between one publisher and a plurality of subscribers, or between a plurality of publishers and one subscriber, or between a plurality of publishers and a plurality of subscribers. In the latter case, the system would preferably be managed by an independent service provider who provides the presentment gateway between the publishers and the subscribers.

Consolidation is also supported. The “publisher” can include several separate entities: a first publisher, a second publisher, and a consolidator. The consolidator consolidates the information from the first publisher and the second publisher to be published in a document.

According to a second aspect of the invention, an electronic document presentment method over the Internet is also provided. The method allows a generic subscriber to access and interact with financial information, published in the form of a document, which information has been supplied by at least one generic publisher. The method includes the following steps:

(a) receiving an electronic request from a subscriber to access a document over the Internet, the subscriber providing identifying details to describe the subscriber's relationship to the information in the document requested, the subscriber being associated with a security term;

(b) processing the identifying details to categorize the subscriber and the subscriber's relationship to the information in the document requested;

(c) selectively permitting the subscriber to access all or a part of the information in the document; and

(d) selectively permitting the subscriber to interact with all or a part of the information in the document.

The subscriber has a defined degree of access and interactivity with the information in the document, according to a security term. Other variations on the method will be inferred from the system description above.

### BRIEF DESCRIPTION OF THE FIGURES

Preferred embodiments of the invention will be described in relation to the drawings in which:

FIG. 1 is a network diagram representing a personal use embodiment of the system;

FIG. 2 is a network diagram representing a multiple-person embodiment of the system;

FIG. 3 is network diagram of network connections and addressing schemes according to the first embodiment of the invention.

FIG. 4 is a schematic diagram of the definitions required to create a peer-to-peer relationship between partner service providers that are connected by a network;

FIG. 5 is a flow chart of the steps required to establish and define a service provider partner relationship.

FIG. 6 is a network diagram of a hosted facility according to the preferred embodiment of the method;

FIG. 7 is a flow chart of the steps required to authenticate a user with a user identification and password according to the preferred embodiment of the invention;

FIG. 8 is a schematic diagram of the method used to uniquely identify the three categories of participant defined by the present method;

FIG. 9 is a diagram representing an identity, as a combination of the person and their business definition;

FIG. 10 is a flow chart of two methods of registration according to the preferred embodiment of the present invention;

FIG. 11 is a schematic diagram of identifiers used to describe a trading partner relationship between a subscriber and a publisher according to the preferred embodiment of the invention;

FIG. 12 is a flow chart of the steps to activate an account-based trading partner relationship between a subscriber and publisher;

FIG. 13 is a sample of a mutual fund statement document as presented to a subscriber;

FIG. 14 describes the document presentment process according to the preferred embodiment of the invention;

FIG. 15 is a schematic diagram of the process to load information from the publisher to the service provider;

FIG. 16 is a flow chart of the steps for a publisher to define a template to present documents;

FIG. 17 is a flow chart of the steps to retrieve document summary information from multiple service providers according to the preferred embodiment of the invention;

FIG. 18 is a flow chart of a subscriber initiating two activities based on links provided in the presented statement shown in FIG. 13;

FIG. 19 is a schematic diagram of an alternate embodiment of the invention called publisher direct;

FIG. 20 is a schematic diagram of an alternate embodiment of the invention called publisher document consolidator;

FIG. 21 is a schematic diagram of an alternate embodiment of the invention where two service providers interact to provide information management and exchange between multiple publishers and multiple subscribers;

FIG. 22 is a schematic diagram of an alternate embodiment of the invention where multiple service providers interact to provide information management and exchange between multiple publishers and multiple subscribers;

FIG. 23 is a schematic diagram of the components comprising the identification of a document according to the preferred embodiment of the invention;

FIG. 24 is a schematic diagram of the components and steps to forward a customized event notification message to a registered participant; and

FIG. 25 is a schematic diagram of a delivery model for electronic statements presented by multiple mutual fund companies according to an embodiment of the present invention.

### DETAILED DESCRIPTION OF THE PREFERRED AND ALTERNATE EMBODIMENTS

In order to convey an understanding of the present invention, a preferred embodiment and a number of alternate embodiments are described using drawings and a step-by-step narrative. However, it is understood that the invention is not limited in scope to these embodiments and that one skilled in the art can discover further applications based on the principles of the invention. In fact, application extensibility to satisfy varying needs of the participants is one of the primary purposes of the invention.

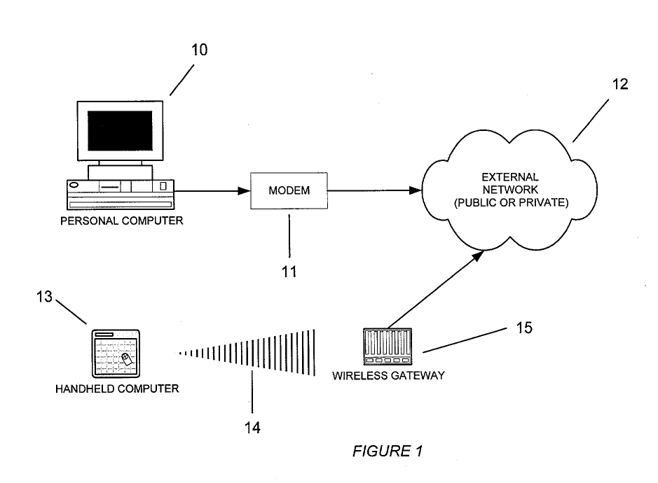

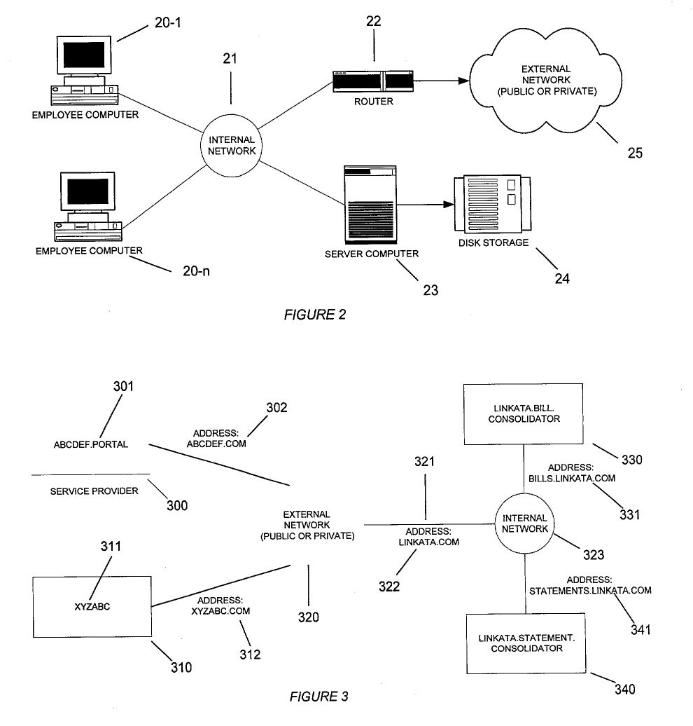

The method is described as a set of processing steps performed on one or more computers connected by a communications network against electronic information. The data may reside anywhere, as long as it is accessible through a network. Two useful computer network architectures are shown in FIGS. 1 and 2, although it is understood that any configuration of network-connected computer systems may be used. A variety of component systems within the network are also useful. FIG. 1 shows a personal computer system. The personal computer 10 itself preferably consists of a keyboard, a monitor, and self-contained memory and disk storage. When such a computer is connected to a shared network 12, a modem 11 is used to convert between the communications medium employed in the home, such as an analog telephone line, and the digital communication that is used by the computer. An alternate method employs a network interface device within the computer that is directly connected to a digital network. Another alternate method employs a device such as a PDA (Personal Digital Assistant) 13 using a specialized wireless network 14 that connects a gateway 15 that translates protocols between the two networks. A current example of such a protocol conversion is WAP (Wireless Access Protocol) to IP (Internet Protocol). The invention should be understood to extend to future personal computing technologies, provided that the network connectivity and hardware requirements are met.

FIG. 2 shows a server-based computer system, which is preferably employed by an organization such as a corporation rather than a single person. The individuals who comprise an organization, such as employees, will each use personal computers 20-1 through 20-n similar to the one 10 described above. These computers are connected through an internal network 21 to a server 23 that handles shared functions such file access and corporate software applications. Due to its broader responsibilities and level of sharing, a server is more powerful than a personal computer, although it is configured using similar components such as memory and communications adapters. A typical implementation may employ external disk storage 24 due to the volume of data that must be managed. The server computer system as it applies to this method will also be connected to an external network 25. Unlike the personal computer, the connection to the external network is generally performed by a more complex hardware component known as a router 22. The router ensures that information passed between two or more multi-user networks (external and internal) is delivered to its intended destination.

The preferred embodiment of the external network is the Internet. The Internet is composed of many smaller interconnected networks that give the appearance of one network to the computer that connects to it. A person arranges with a commercial Internet Service Provider (ISP) to provide access to the Internet for a fee. Once connected, a person can access other computers on the Internet using a symbolic name known as a “domain”. A domain can be represented by one computer, a portion of one computer delimited from other domains by software, or a set of computers. It is not required that the computer which accesses the domain be aware of the domain-setting method used. Resources such as programs, Web pages, and visual images may be accessed through the use of a URL (Universal Resource Locator) that contains the domain name plus the name of the resource as it is known to the computer. Once two computers are connected over the Internet, information can be exchanged using one of a number of standard protocols. HTTP (Hypertext Transfer Protocol), FTP (File Transfer Protocol), and SMTP (Simple Mail Transfer Protocol, more commonly known as “e-mail”) are three of the most widely used. The software that operates on each computer understands these protocols. The preferred software implementation on the personal computer is a browser, which can access resources over the Internet and present them to the person using the computer in a manner that is appropriate to the type of resource. The preferred software implementation on a server computer is a Web server and, optionally, an FTP server and SMTP server. Additionally, the server may also employ application server software to execute application programs and database management software to manage persistent information (i.e. information to be stored beyond the life of a particular transaction). This software may or may not reside on a separate computer connected to an internal network. Alternate embodiments to the Internet include private networks or point-to-point leased connections. From the perspective of the present invention, the computers and networks described are illustrative only; it is essential that the system be able to operate on a plurality of configurations.

The decreasing costs of computer systems and the widespread availability of network services ensure that virtually any person or organization can satisfy the infrastructure requirements to act as a participant in the system described here. Furthermore, the ubiquitous nature of communication services allows people to access networks from virtually any location in the world and the convergence of standards in the Internet means that a person or organization can use any suitably equipped computer system and the services of any Internet connectivity provider. The present invention seeks to complement this fluidity and location-independence rather than impede it.

The method relies upon a set of generic entities, processes, and operating rules that are common to all applications of the invention. The method allows the permutation and extension of these entities and processes while complying with the rules. The entities serve as models for concrete definitions when the invention is applied. One or more entities interact according to a process. The service provider and service provider domain are entities that impact on other entities, as defined herein. A service provider is an entity that manages external information on behalf of the owners, provides the logical access point for participants, and serves as the agent that allows participants to exchange electronic information. The preferred embodiment is a service provider operated by a single organization using a server computer system such as the one shown in FIG. 2. Alternatively, one organization may define multiple service providers or one service provider may be owned by multiple organizations. This independence is captured by the service provider domain, which is a logical definition comprising the set of services, participants, and resources managed by a single service provider. In the preferred implementation, the service provider domain corresponds directly to an Internet domain. Alternative implementations can use similar network standards to define a service provider domain. For example, the ANSI X.400 standard of administrative and private domains can be mapped to service provider domains. The key is that the names of the service providers be unique relative to each other, regardless of the network on which they are deployed. The reason for this restriction is that the intent of the invention is to facilitate information management, including delivery, between participants regardless of their location.

FIG. 3 shows a minimal implementation of network-connected service provider domains. Each service provider is assumed to operate on a server-based computer system as described in FIG. 2. The first service provider 300 is named ABCDEF.PORTAL 301 and is accessible via the Internet at domain or address ABCDEF.COM 303. The implementation of the system on that computer maps the Internet address to the service provider name. The name is unique among all service providers that may potentially exchange information with each other. One method of ensuring such uniqueness is to employ a central administrator that arbitrates the granting of such names. The preferred implementation is to use the Internet domain name as the name, which will be, by definition, globally unique. Another independent service provider 310 named XYZABC 311 at Internet address XYZABC.COM 312 is shown. Both service providers are connected to the Internet 320 using their selection of communication provider. Another corporation, called “Linkata” in the example, operates a multiple service provider data center with a shared connection 321 known as domain LINKATA.COM 322. An internal network 323 manages the communication between the server computers and the Internet. Within the internal network, two service providers are defined. These are LINKATA.BILL.CONSOLIDATOR 330 and LINKATA.STATEMENT.CONSOLIDATOR 340 which are network-accessible at addresses BILLS.LINKATA.COM 331 and STATEMENTS.LINKATA.COM 341, respectively. These addresses are “subdomains” of LINKATA.COM.

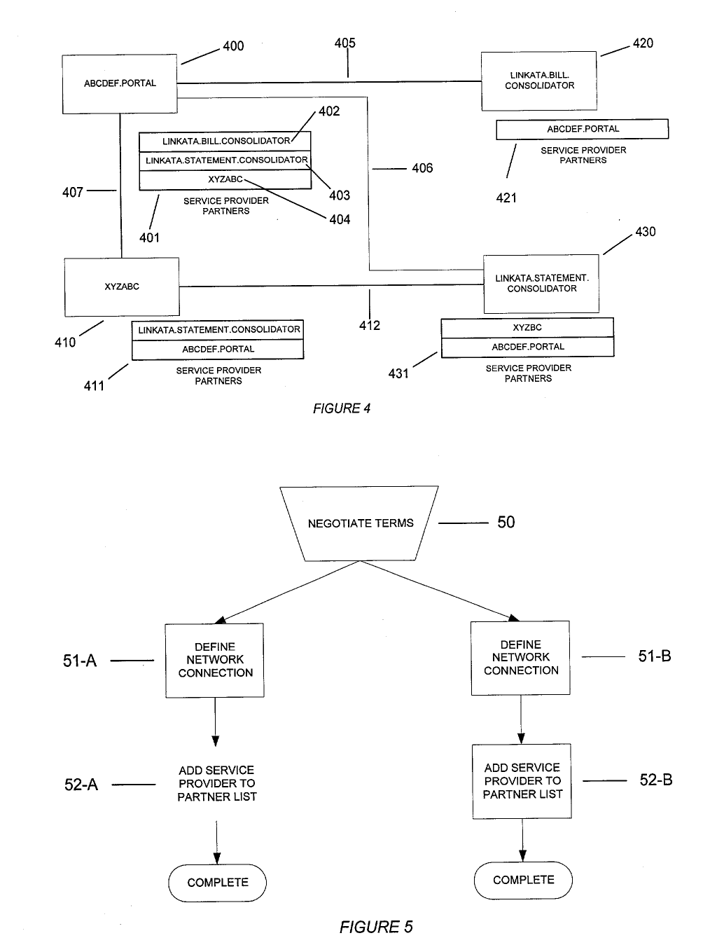

Although all of the service providers in FIG. 3 are connected via a network, there is not necessarily an ongoing contractual or business relationship between the service providers. The relationships are peer-to-peer in that both service providers must agree to the relationship. In FIG. 4, an illustration of one possible definition of service provider relationships is shown. This figure is an example of one possible configuration. A description of business model implementations based on service provider relationships is provided below. In FIG. 4, the same service providers from FIG. 3 are shown. ABCDEF.PORTAL 400 has a relationship with all three of the other service providers 405 406 407. These relationships are defined in a partner list 401, which contains entries for each partner service provider 402 403 404. In addition to the partner names, each entry contains connectivity information such as the network address of the partner as well as a definition of the capabilities of the partner. These additional details are not shown in the illustration as they can be extended depending upon the uniqueness of the relationship and the terms of the agreement between the two. Also shown is a relationship 412 between XYZABC 410 and LINKATA.STATEMENT.CONSOLIDATOR 430 that is reflected in the service provider partner lists 411 and 431, respectively.

FIG. 5 describes the steps taken when a service provider relationship is established. One of the two service providers contacts the other and the terms of the relationship are negotiated 50, the specifics of which are not mandatory to an understanding of the method. The next steps are conducted in parallel at the respective service providers. The network connectivity is established 51-A 51-B (such as by an exchange of Internet domain names). Alternate implementations may involve the installation of a private point-to-point communications line or the establishment of a cryptographic relationship for security.

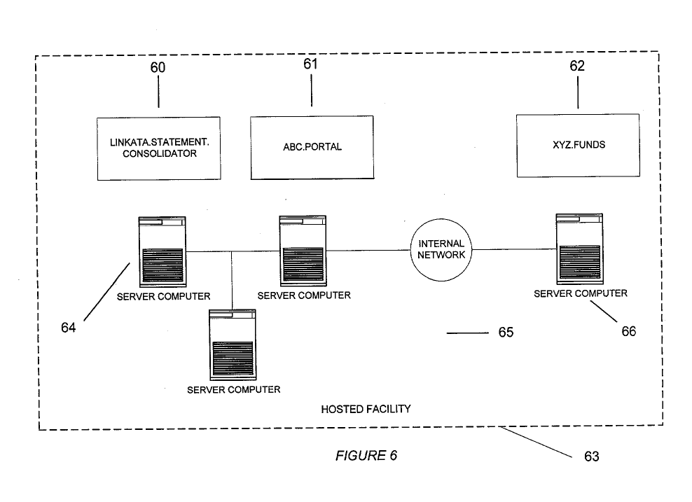

A hosted facility or data centre may be provided, which is an entity comprised of a server and network infrastructure deploying the service provider domain. In the basic implementation, the service provider and the owner of the hosted facility are the same entity. Alternative implementations are also useful, such as a service provider engaging the hosted facility operator to operate the infrastructure required for the service provider domain. Furthermore, a hosted facility may operate multiple service providers with varying fee-based classes of service, as shown in FIG. 6. Three service provider domains are shown: LINKATA.STATEMENT.CONSOLIDATOR 60, ABC.PORTAL 61, and XYZ.FUNDS 62. These domains are deployed on a hosted facility 63 suitably equipped to handle the service level requirements of all three. The first two service providers are deployed on a shared fault-tolerant cluster of servers 64. XYZ.FUNDS, on the other hand, contracts with the hosted facility operator to be deployed on an exclusive server 66. Preferably, firewalls or similar security mechanisms 65 are employed to isolate the service providers 64 from the hosted facility operator 66.

The subscriber, publisher and third party entities have both internal and external identifications. The internal identification is significant only within a given service provider domain while the external identification has significance to all other service providers. This separation is important for preserving the security of the system. The internal and external identifiers may also be described as a “security term”.

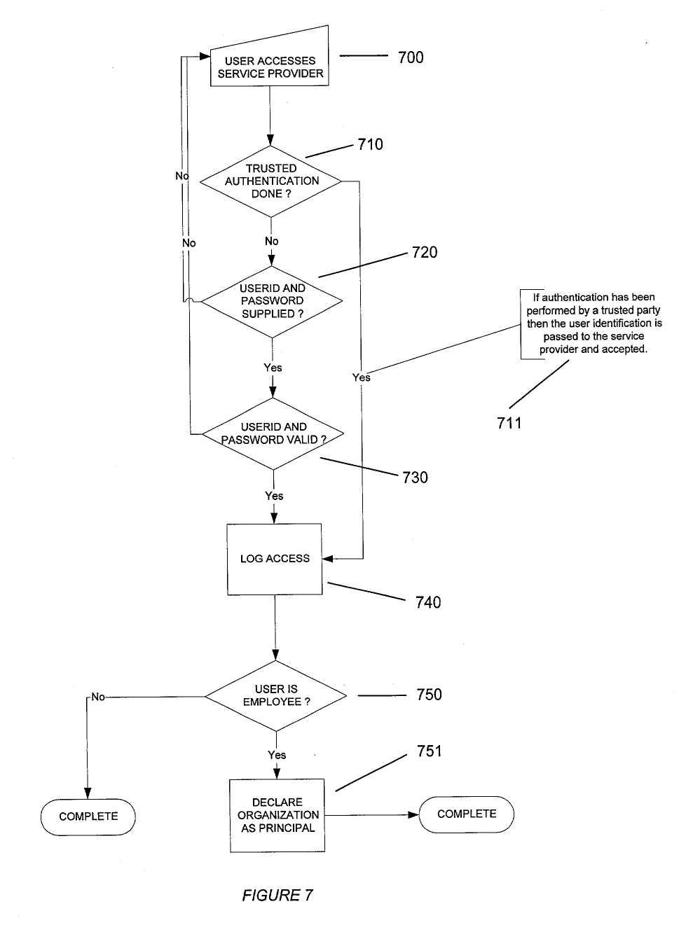

Each person or organization that makes use of the service provider is defined independently of their role and business characteristics. The information presented has a degree of permanence, and therefore secured access is critical. Each individual that accesses the managed information must be known and must provide proof of identity using the identification and credentials (password) supplied by the service provider during registration prior to gaining access. The basic implementation of authentication involves a user identification and password. Alternative implementations allow for PKI (Public Key Infrastructure), single-signon, and other cryptographic solutions. In FIG. 7, a person accesses 700 the service provider at a known network address using a personal computer or similar device as shown in FIG. 1. The service provider must first determine whether another trusted party has already authenticated the user 710. As an example, the trusted party may be software that performs single-signon, meaning that the person is authenticated once and that other “back-end” software bypasses normal authentication. The trust may be achieved through a mechanism such as shared cryptographic keys or digital certificates. If this is the case 711, then the identification of the person is accepted as presented. If this is not the case, the service provider determines whether the person has supplied a user identification and password 720. If not, then a screen is presented that asks for a user identification and password. Once the user identification and password have been supplied, they are verified for authenticity 730 using a security mechanism such as a password file. Once authentication is successful, the user identification is accepted as representing that person and the time of access is logged 740. If the person is acting as an employee of an organization that is known to the service provider 750, the identification of the organization is declared to be the principal 751 for all activity conducted between the person and the service provider. Otherwise, the user identification is considered to be the principal.

The existence of an entity called the principal allows business relationships to be defined independently of whether the involved parties are individuals or organizations. This is consistent with the purpose of the invention, which is to support different applications such as B2C, B2B, and P2P (person-to-person). Since a principal can be either a user or an organization, the identification method must be the same for both. Furthermore, since the identification is managed by a security system, this identification is also used to define rules that govern access to protected resources within the service provider domain. The identification has no meaning to and should not be exchanged with other service providers to protect the security of the system. Thus, the method of principal identification is left to the discretion of the arrangement between the hosted facility and the service provider. A typical implementation would involve identification and password of up to 16 alphanumeric characters each.

Although the authentication scenario described is the preferred embodiment, alternate methods of access are valid using the same process. These include, but are not limited to, automated processes on remote computers that can supply identification and a password and act on behalf of the named principal.

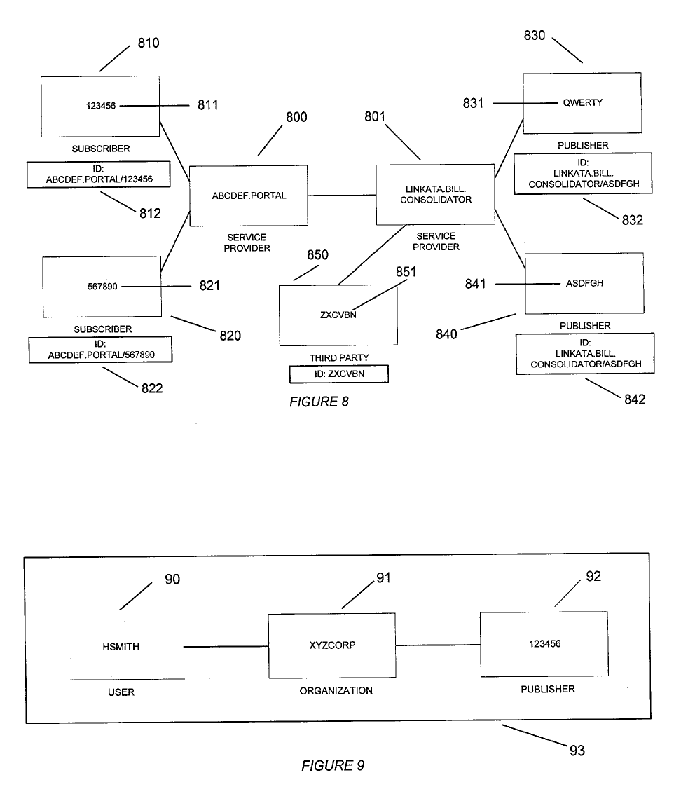

There are three additional entities—subscribers, publishers, and third parties—which are associated with the business activities that a principal conducts within the scope of the present invention. The publisher is the originator and owner of the external information that is managed by the service provider. The subscriber is a recipient or viewer of that information, and may interact with that information. The third party is any entity that facilitates the management and exchange of the information; in fact the service provider itself is considered to be a third party. These three entities are collectively known as “participants” herein. Each participant has an associated set of capabilities and responsibilities within the present invention, as will be described below. The service provider for a given participant sets the identification of the participant. This identification is intended to uniquely identify the participant globally. Uniqueness may be accomplished by an aggregation of the service provider name and the participant identification, as shown in FIG. 8. Two service providers ABCDEF.PORTAL 800 and LINKATA.BILL.CONSOLIDATOR 801 each have two participants defined. The two subscribers 810 820 are assigned identifiers 123456 811 and 567890 821, respectively. The two publishers 830 840 are assigned identifiers QWERTY 831 and ASDFGH 841, respectively. The global identifications for these participants are shown as a combination of the service provider name and the assigned identifier 812 822 832 842. Since a third party is significant only to the service provider in which it is defined, there is no need for a global identification for a third party. Any business relationships between a third party and any of the other participants are not relevant to the method being disclosed here. In FIG. 8, a third party 850 identified as ZXCVBN 851.

The preferred embodiment mandates a common method of participant identification among all participating service providers and that method is 32 alphanumeric characters. Alternate embodiments are allowed, but it is the responsibility of each implementing service provider to translate identifications that travel outside their domain to be compliant with the preferred embodiment.

In keeping with the stated purpose of the invention, principals and participants can be combined as needed for the given business relationship. This combination is known as an identity. FIG. 9 shows one possible implementation of an identity within a service provider domain where a person with user identification HSMITH 90 is an employee of an organization identified as XYZCORP 91. The organization also has a business definition as a publisher called 123456 92. In this case, the organization XYZCORP is the publisher when describing business relationships. The person HSMITH acts on behalf of the organization but is not part of any business relationship definition.

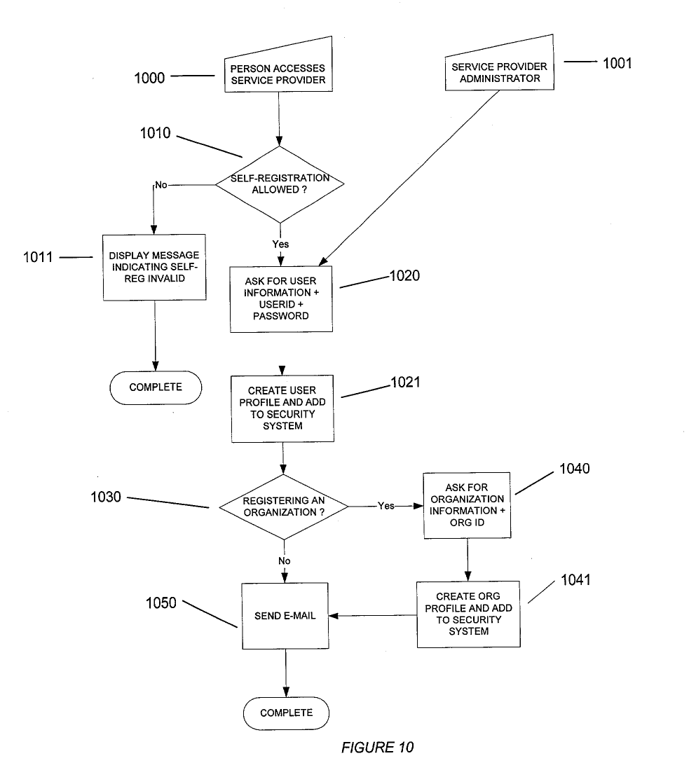

The establishment of a relationship between a principal and a service provider is called registration. This process also creates the participant definition that reflects the intended business purpose of the principal, thus establishing an identity. The two preferred embodiments for registration are self-administered and centrally administered. In FIG. 10, two entry points are shown representing the two embodiments. A person attempting to self-register 1000 accesses the service provider at a known address. If the service provider does not allow self-registration 1010, a message is displayed to the person indicating this. If it is allowed, the person is shown a data entry form 1020 that asks for information about the person, including their desired user identifier and password. The service provider discloses information such as maximum and minimum password lengths on the same display. Alternate implementations may algorithmically generate the userid and password rather than allow user selection. This information is used to create a user profile on the server disk storage 1021. Additionally, the user identification and password is added to the security system. If the principal being registered is an organization 1030, additional steps are required. The person is shown a data entry form 1040 that asks for information about the organization including the desired organization identifier. This information is added to an organization profile as well as the security system 1041. The final step is to send an electronic mail message to the newly registered person. In the case where registration is centrally administered, an employee of the service provider accesses the service provider domain 1001 and performs the same steps as the person who self-registers.

Alternate embodiments may add additional steps to ensure the identity of the person being added, such as sending a one-time activation code to a known mailing address in order to complete self-registration.

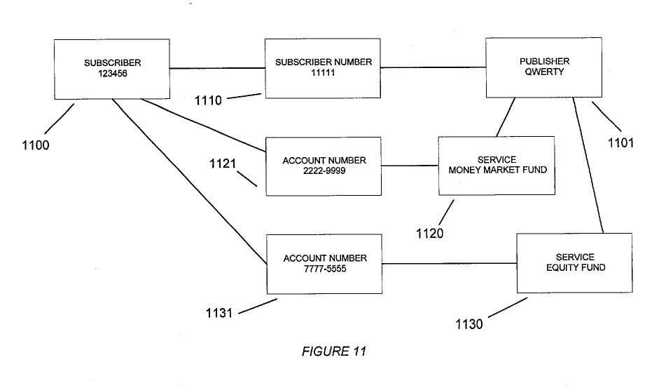

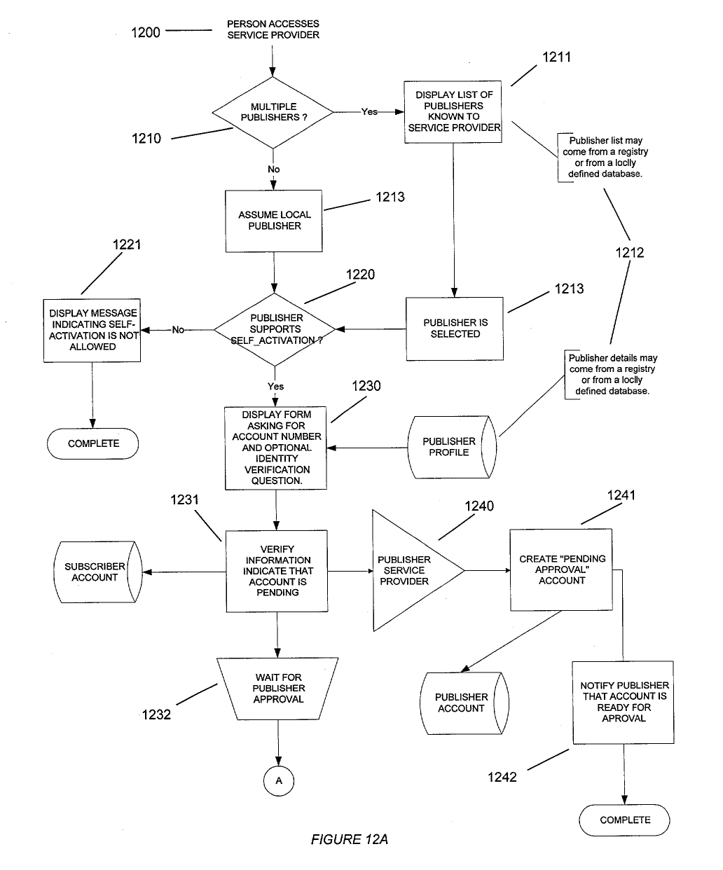

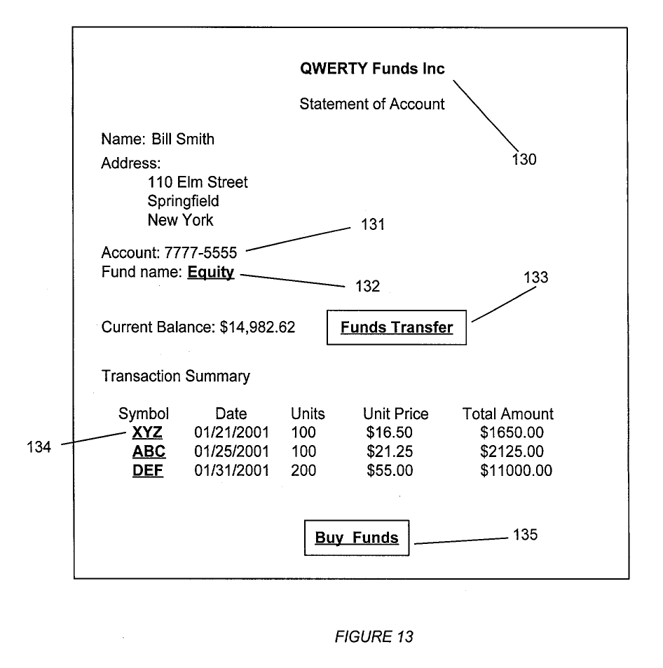

A unique aspect of subscribers and publishers is the existence of a pre-existing business relationship in which the exchange of external information is merely one aspect. Enhancing that relationship is a core purpose of the present invention. The specifics of this relationship are beyond the scope of the service provider domains but will be captured in the entity and process definitions set through the service provider. In the course of its business the publisher may make one or more services available and establish arrangements with individual subscribers that define terms of payment, dispute resolution, and delivery. The service-level relationship is defined by way of an account. For example, a bank provides financial services for its customers where each subscribed service is represented by an account. In FIG. 11, a schematic diagram of one such service-based relationship is provided. The subscriber 1100 and publisher 1101 are the same as those described in FIG. 8. The service provider identifications are included for descriptive purposes only and are not part of the service arrangement between the two parties. In the preferred implementation, the publisher assigns a subscriber number 1110 to represent the relationship in general. Alternate implementations will not employ the subscriber number, in which case the subscriber number is assumed to be identical to the account number. The subscriber has accounts for two of the services offered by the publisher: Money Market Fund 1120 and Equity Fund 1130. Two accounts numbered 2222-9999 1121 and 7777-5555 1122 have been assigned to these subscriptions, respectively. A sample statement, the type of which would fall into the category or external information as defined by the present invention, is shown in FIG. 13. The actual corporate name of the publisher is shown at the top of the statement 130 while the account number 131 and commonly understood name of the service 132 are also shown on the statement. It is at the discretion of the publisher whether the subscriber number is shown. In this example, the subscriber number is not shown because its purpose is to be an internal control for the publisher.

The publisher assigns subscriber and account numbers at the time that the service is initially subscribed to and the format and structure of these identifiers will be at the discretion of the publisher. The presence of two identifiers allows a two-tier definition of various and complex publisher-subscriber relationships, which is consistent with the purpose of the present invention. The responsibility of the method is to define a maximum length that serves as a guideline for implementation. This maximum length is set as 64 alphanumeric characters; service providers are mandated to maintain these numbers as the publisher provides them. Furthermore, the definition of a service is also at the discretion of the publisher.

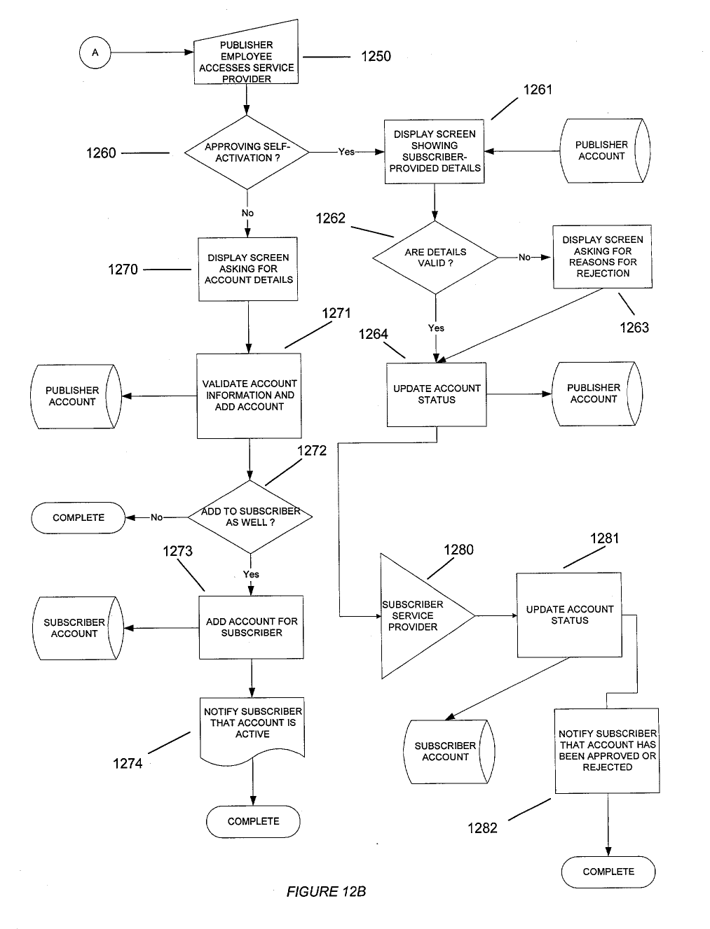

In order to manage the information exchange between the two parties, the account information must be added to the system in a process called “activation”. The two preferred embodiments for activation are self-administered and centrally administered. Activation fulfills two purposes. First, the information is added to the service provider infrastructure. Second, the intent is conveyed to migrate to electronic information delivery between the two parties. Activation is carried out in two discontinuous processes that are separated by a period in which the publisher must verify the identity of the subscriber. In FIG. 12A, a subscriber accesses 1200 the service provider with which he/she has registered. The service provider determines whether there are multiple publishers available for account activation 1210. In the preferred embodiment of the invention, this list would be obtained from an independent registry 1212 such as the one disclosed by PCT International Patent Application PCT/CAOO/01048 for an “Electronic Bill Presentment and Payment System and Method Providing Biller Directories”. A valid alternative is when the service provider is self-contained or within a closed community. In such a case, the set of known publishers may be maintained locally. If more than one publisher is available, a list is presented to the person representing the subscriber 1211 where one is selected. If that publisher does not support self-activation, a message is displayed to the subscriber 1221. If it is supported, a data entry form is displayed asking for the account number as well as answers to one or more identity verification questions 1230. These questions request information that only the subscriber and publisher should know such as the balance of the last statement. The publisher defines these questions; the service provider is only responsible for presenting them to the person who is activating the account. The account information is verified 1231 and the account is added to the subscriber account database with a state of “pending”. The subscriber must then wait for approval by the publisher 1232. At the same time, the request for activation is forwarded 1240 to the publisher service provider assuming that a peer relationship between the service providers exists as defined in FIG. 4. When the request arrives at the publisher service provider domain, an account is added to the publisher account database 1241, also with a state of “pending”. The publisher is then notified that an account activation request has been received.

In FIG. 12B, the process is resumed after some period of time where the publisher has been notified and an employee has signed on 1250 to the service provider with which the publisher is registered. The details of the activation request are displayed to the publisher 1261 and the employee approves or rejects on the basis of the information provided 1262. If the account activation is being rejected, a reason must be given 1263 that will help the subscriber to resolve the problem. Regardless of the decision, the publisher account is updated to reflect the new status. The subscriber service provider is notified of the change in account status 1280, at which time the change is reflected in the subscriber account 1281. The subscriber is then notified 1282 of the approval or rejection via electronic mail or similar notification mechanism. The second preferred method of account activation is shown as an alternate path in FIG. 12B. If the publisher employee is adding a new account 1260, a screen is presented 1270 that asks for details about the account including the name and address of the subscriber as well as the account number. If the information is valid, the account is added to the publisher account database 1271. If the intent is to add the account to the subscriber as well, it is added at the same time 1273. This can only be done if the subscriber resides on the same service provider as the publisher because the publisher has no access to a similar registry of subscribers. Once the account is added to the subscriber account database, the publisher would then arrange to notify the subscriber. This can be done through electronic mail or through an offline mailing. An alternate application is shown at 1272, where the account may be added to the publisher account database only. This is valid where the only application is customer support and the service provider is being used as an archiving mechanism.

Valid alternate embodiments are numerous depending upon how the publisher plans to migrate from a paper-based method to the electronic method defined here. In one such embodiment, the publisher uploads new accounts with pre-defined answers to the identity verification questions. The publisher mails these answers to a known address. When the subscriber performs self-activation, this answer (e.g. a randomly generated number) is supplied. The approval process is automated by comparing the supplied answer with the loaded answer, thus eliminating the elapsed time between request and approval from the perspective of the subscriber.

When a publisher decides that information is to be made available to its subscribers, it is transferred to the service provider domain with which the publisher is registered. The content of the information and the timing of its delivery are at the discretion of the publisher. The basic unit of information that is exchanged between the publisher and the service provider is a document. A service provider must disclose prior to publisher registration the types of documents that are supported. The minimum types that are required by the system are bills, statements, notices, invoices, and reports. The addition of other document types by a service provider is not limited by the present invention. FIG. 13 shows a typical mutual fund statement that can be presented. The statement includes information that would be present on its paper-based equivalent including the name of the fund broker 130, the account number 131 and fund product name 132. Additionally, if the statement is presented on a network-connected computer such as the one shown in FIG. 1, a number of URL links to other services are included. The links include the location of the service plus any parameters that are required to specify the request. One such service 132 provided by the publisher shows detailed information about a fund product called Equity. Another service 133, likely operated by a financial institution, allows the viewer to initiate a funds transfer from his or her banking account to an account at the fund manufacturer. A third service 134 is provided by a stock listing service that displays information about a traded stock when the symbol of that stock is supplied. A final service 135 allows the customer to buy more funds using an online service provided by the fund manufacturer itself or by a third party.

A document is identified in several ways, reflecting the different relationships that are represented by a document. FIG. 23 depicts the components of document identification and describes a special type of document called a package 2300. A package is a document that contains other documents, allowing all of the contained documents to be treated as one. The use of a package is an optional embodiment of the invention; the first embodiment is that all documents are independent; that is, they are not affiliated with a package. In the figure two financial institution statements are shown: one for a savings account 2310 and one for a checking account 2320. The identification components are the same for all document types. The first part of the identification reflects the publisher of the document as defined by the registering service provider and described in FIG. 8. These are the service provider name 2334 and the publisher identifier that was assigned by the service provider 2335. The second part of the identification is assigned by the publisher and consists of the cycle name 2332, the account number 2336, the document name 2333, the document type 2330 and document subtype 2331. A cycle is an aggregation of documents that is delivered from the publisher to the service provider as one unit. In the preferred embodiment, a publisher cycle is based on the periodic nature of document distribution; for example, a cycle of account statements is created monthly for every account. The definition and content of a cycle is at the discretion of the publisher; the present invention only mandates that a cycle identifier be 32 or fewer alphanumeric characters. The document name is assigned by the publisher and is intended to provide a unique identifier that is independent of the service provider and that is used to track activities against the document such as account reconciliation and customer service dispute resolution. An example of a document name is an invoice number. The present invention only mandates that a document name be 32 or fewer alphanumeric characters. The final component of document identification is the UUID (Universally Unique Identifier) that is assigned by the service provider. A UUID, as its name implies, is intended to be universally unique. No single UUID generation algorithm is mandated, so long as the uniqueness requirement is met. One method is described by ISO standard 11578. This composite document identifier allows different parties to identify a specific document using different elements of the identifier. For example, a publisher can refer to the account number and document name when interacting with a subscriber and be assured that the identification is unique. A partner service provider, on the other hand can refer to a document by the service provider name and UUID regardless of the owning publisher. In keeping with the intent of the method, different information management applications can be deployed that use different combinations of the document identification components. In FIG. 23, the package is identified at 2301 while the two statements that are part of the package are identified by 2311 and 2321.

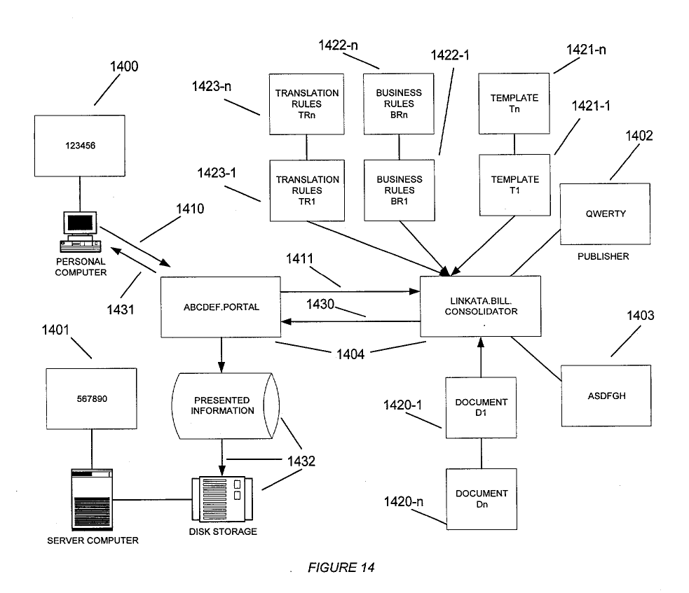

The process by which document information loaded by a publisher is converted into a defined format (such as the one depicted in FIG. 14) is called presentment. In the figure, two publishers named QWERTY 1402 and ASDFGH 1403, and two subscribers named 123456 1400 and 567890 1401 are shown. Also shown are two partner service providers named ABCDEF.PORTAL and LINKATA.BILL.CONSOLIDATOR 1404. In the first embodiment, the presentment process is initiated 1410 by a person using a suitably equipped personal computer, as described in FIG. 1, by entering a command or invoking a URL link that was made available by the service provider server computer over the intervening network. Alternate embodiments can be implemented by a person skilled in the art that allow the request to be initiated from another device such as a hand-held computer or through a scheduled event at the service provider. The request is sent 1412 to the service provider that manages the document on behalf of the publisher, in this case LINKATA.BILL.CONSOLIDATOR. The request must specify the identifier of the document or documents, the preferred rendering format (such as HTML) and the language and country of the viewer. The presentment process locates the documents 1420-1 to 1420-n and loads them into memory. Multiple documents may be selected if the goal is to produce a single view. For example, after an acquisition, the acquirer may want to display consolidated customer statements for all services. Next, a suitable rendering template is located based on the document identification, the parameters from the original request, and the date of the document. The document information is used to select the templates 1421-1 to 1421-n that are built to accept that document type as input. The request information is used to trim the list of templates by selecting the ones that also can produce the desired output format in the language that most closely reflects the viewer preference. The date is used to select the template that was in effect at the time that the document was originally created. This allows rendered documents to maintain their historic accuracy as display formats are changed over time. If the rendering can only be accomplished through multiple conversions, then multiple templates may be selected. The next step is to select zero or more translation rules 1422-1 to 1422-n and zero or more business rules 1423-1 to 1423-n that are used to further customize the look of the document. Translation rules are used to produce information that makes sense to the viewer from information that is internal to the publisher, e.g. a product code translated into a product description. Business rules are used to augment the display depending upon parameters specified by the publisher. For example, a retailer may wish to promote different products at different times of the year. Business rules would select an appropriate marketing message depending upon the current date. The next step in presentment is to deliver the rendered document to the subscriber. In the preferred embodiment, the information is sent to the service provider from which the original request was sent 1430. Once there, the service provider is responsible for delivering the document to the subscriber. It may be sent to the computer which originated the request for presentment 1431, where it is displayed by the browser software that is installed on the computer. An alternate embodiment is where the subscriber is an organization and the document is delivered in an offline manner triggered by a scheduled event. In this case, the document is written to disk within the service provider hosted facility and sent to the subscriber server computer where it is written to local disk storage 1432. In the preferred embodiment, the method of transferring the document can be a standard file transfer protocol such as FTP or a proprietary mechanism supported by both computers. The decision is an aspect of the service agreement between the subscriber and the service provider and is not mandated by the present invention.

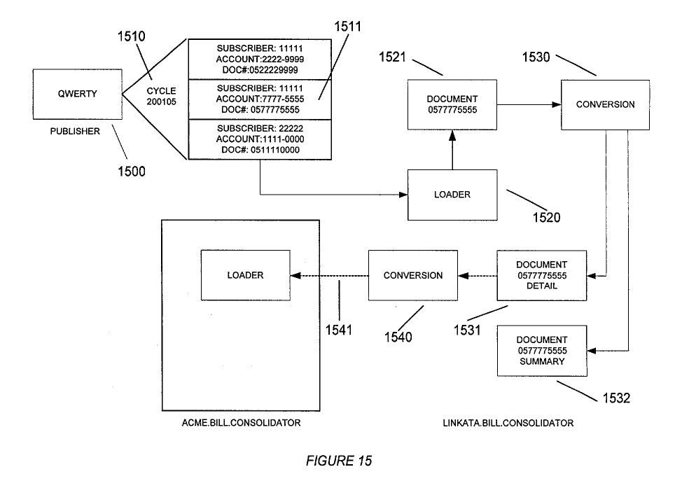

The information that is managed by the system that implements the method described here is originally produced by the publisher. In the preferred embodiment, this information is produced by software that fulfills part of the subscribed service. The method by which the production of the information is triggered is not mandated by the present invention. In the paper-based model, the information is rendered to a paper document and delivered to the subscriber by the postal system or a contracted third party. In the present invention, the information is rendered electronically and sent to the service provider with which the publisher has an arrangement. In all likelihood, the same system that produces the paper-based documents will also produce the electronic version. In FIG. 15, the publisher 1500 produces the information that is intended for external delivery. In the preferred embodiment, the documents 1501 are aggregated in a cycle 1510 that represents the periodicity of document production. The cycle is delivered to the service provider as a single unit. Upon receipt, the cycle is processed by a software component called a loader 1520 which is primarily responsible for validating the contents of the cycle aggregate and extracting individual documents 1521. Extracted documents are subjected to an optional conversion step 1530 where the proprietary format used by the publisher is converted to a standard machine-readable detail format 1531 and where a separate summary 1532 is extracted. In the preferred embodiment, the document detail is converted to XML (Extensible Markup Language), which is uniquely suited for representing precisely identified information elements independently of rendering instructions such as color and font. The summary is used for searching and listing of documents while the detail is used only when the document contents are rendered. Both the summary and detail are stored on disk by the service provider. The hosted facility is expected to employ infrastructure and procedures to ensure the integrity of the information, including database software, regular local and offsite backups, and redundant hardware. The figure illustrates an alternate embodiment where the document detail is converted 1540 and forwarded 1541 to another service provider. This method shifts the responsibility for dealing with multiple service providers from the publisher to the service provider with which the publisher is registered.

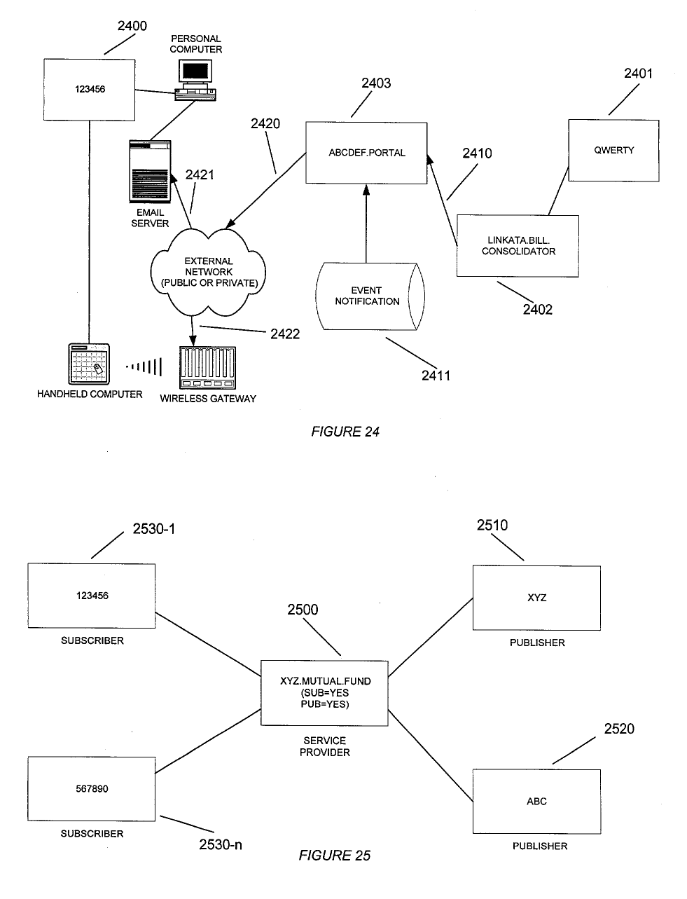

Once the documents have been loaded and made available for viewing, the intended recipient must be notified that there is information available for them. In the present invention, this requirement is provided by a general-purpose event notification capability. In this case, the event is that new documents are available for viewing. FIG. 24 depicts the flow of processing involved in the event notification process. Here, two service providers named ABCDEF.PORTAL 2403 and LINKATA.BILL.CONSOLIDATOR 2402 are defined. Also defined are a subscriber identified as 123456 2400 and a publisher identified as QWERTY 2401. The event is initiated after the publisher loads a document intended for the subscriber. Since the subscriber is registered with another service provider, the event must be forwarded to that service provider 2410. Once the event arrives, the system retrieves the event notification definition from disk 2411. This definition contains the text of the notification message, optionally in multiple languages, as well as the delivery method. In this case, the notification message could be: YOU HAVE DOCUMENTS READY FOR VIEWING. The notification message is built and sent to the subscriber 2420. The diagram shows two alternate methods for delivering notifications, although the method does not in any way limit the notification delivery capability to these two methods. The first option is to deliver the notification as an e-mail message 2421. It is delivered to the server that operates the subscriber's e-mail service and is retrieved by the subscriber using a personal computer. The second option uses a wireless network and a hand-held computer 2422. The advantage of the latter method is that some handheld devices such as a pager can alert the recipient immediately.

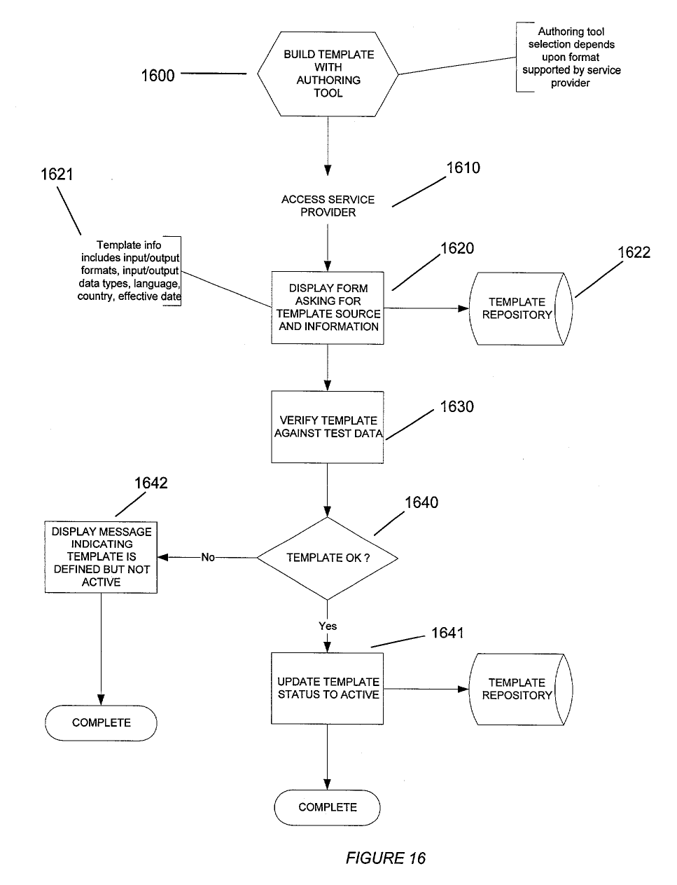

Publishers are responsible for defining how the rendered document will appear to the subscriber. The appearance is governed by an entity known as a template, as described in the presentment process illustrated by FIG. 14. Publishers may define their own templates or contract the responsibility to a third party, such as the service provider. The present invention does not mandate an algorithm or format for the template, although the preferred embodiment is XSLT (Extensible Style Language Transformation) which is an XML-compliant language for transforming one XML document to another. The allowable template specification methods are defined by the service provider and must be disclosed in the service agreement with the publisher. FIG. 16 depicts the steps involved in defining a new template. The first step 1600 is to create the template using an authoring tool supplied by the service provider or by an independent party. Once the template is created, the publisher or authorized agent accesses the service provider domain 1610 using a personal computer and is authenticated in the manner described by FIG. 7. The system displays a data entry form 1620 asking for identification for the template and where the details can be found. The identification information 1621 includes the input and output formats, input and output data types, the rendered language and country, and the effective date. The formats are how the information is represented, including HTML, XML, ASCII text, PDF (a popular proprietary format developed by Adobe Systems™). The data types are publisher-defined values that describe for purpose of the information. For example, an input data type of SAVINGS can mean that the document used as input to the rendering process is a savings account statement. An output data type of TRANSACTIONS can mean that the rendered output is the summary of transactions against that account, a subset of the original document. Language and country are used to produce rendered documents that are in multiple languages and/or national standards. For example, a publisher may wish to render the savings account statement in English and Spanish, where English is the default. This would require two templates, one that specifies a language of Spanish and a second that specifies a “wild-card” value for language. If the viewer indicates Spanish as the language of preference, the Spanish template will be chosen. If the viewer indicates German as the language of preference, the second (English) template will be chosen, causing the statement information to be presented in English, since German is not available and English is the default. The effective date defines when the template becomes valid. This allows templates to be preloaded by setting a future date or allows older documents to be rendered as they were intended, even if newer documents use a modified format. The template detail can be transferred to the service via an offline process such as via an electronic mail attachment send to an administrator or directly from the computer of the person accessing the system. Regardless of the choice, the template is stored in a template repository 1622 where it is retrieved by the presentment process described previously. The publisher also has the option of validating 1630 the template by invoking the presentment process against pre-loaded test data. The publisher is asked to verify that the template is valid 1640 and, if so, the template is marked as available for use 1641. If not, the publisher is informed that the template is not valid and is being held as pending approval before it can be used to render a live document.

The same process is preferably used to define translation rules and business rules since both are tied closely to templates.

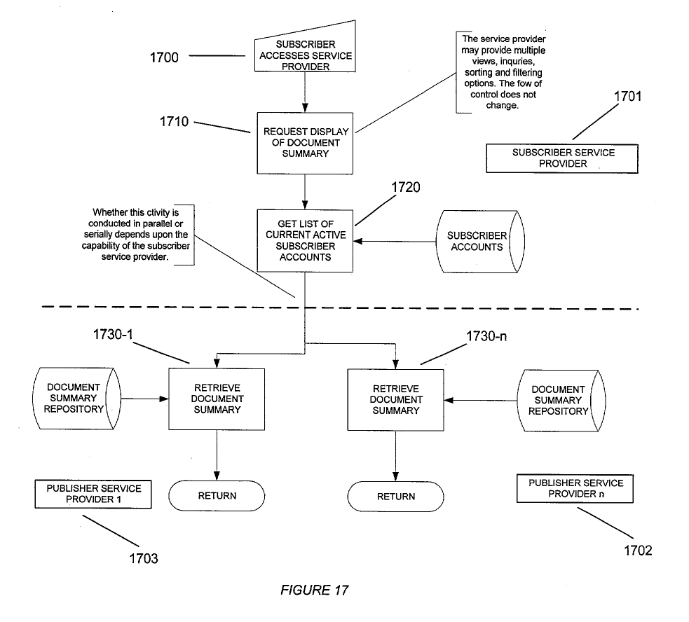

The document loading process described above and depicted by FIG. 15 specifies that a summary is extracted from the publisher document as part of the loading process. This summary is used to implement search and list capabilities for users. In FIG. 17, the steps involved in a document summary list are defined where the subscriber service provider and publisher service provider are not the same entity. The case where both trading partners are registered with the same service provider follows the same model, except that some efficiency is gained by not including the network latency that may exist between partner service providers. Here, three service providers are shown: one services the subscriber 1701, while the other two 1702 1703 service two publishers with which the subscriber has a relationship. The first service provider has a partner relationship with each of the other two as described above and in FIG. 4. The subscriber initiates the process by accessing the service provider facility 1700. The subscriber then requests a list of documents 1710. The service provider may provide any number of tools and customized user interfaces including sorting, searching, and filtering to create criteria for the generation of the list. The service provider must obtain the set of activated accounts that are owned by the subscriber and that are applicable to the list being requested 1720. Each account will identify the service provider that is managing the documents for the publisher that also owns the account. The service provider sends a request for a document summary list to each distinct publisher service provider 1730-1 1730-n, where the request is fulfilled by retrieving the appropriate document summaries. These are returned to the subscriber service provider, consolidated, and presented as a single list. The document presentment logic is invoked from such a list in the preferred embodiment of the model.

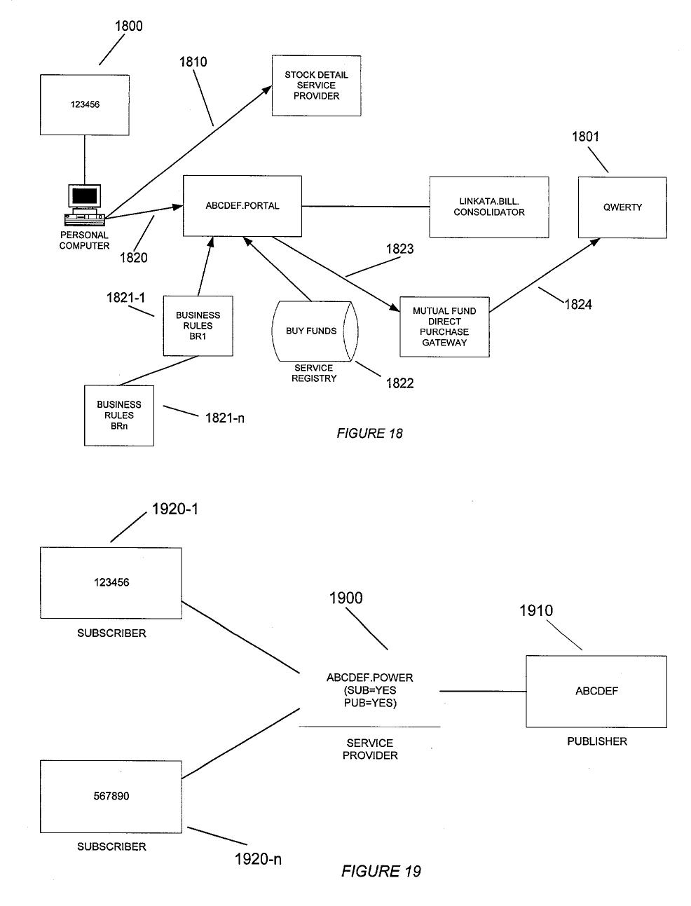

Once the document is presented to the viewer, business functions may be invoked directly from the document using information that is present in the document. An example of such a document is the mutual fund statement shown in FIG. 13. On that statement a number of links to business functions were described. FIG. 18 provides a description of the process that is fulfilled by two of those functions. The subscriber 123456 1800 is viewing the statement shown in FIG. 13. When the person invokes the link depicted by 134, the browser accesses the URL of a stock detail service provider 1810, passing the symbol XYZ. In the preferred embodiment, the URL will have been generated by a translation rule during the presentment of the statement. Alternatively, the URL may be a symbolic name that is resolved to a real Internet domain by way of an independent registry. The information presented by the stock detail service provider is not described by the present invention. When the person invokes the link depicted by 135, a request is sent to the service provider to purchase more funds 1820. Prior to performing the function, the service provider accesses optional pre-defined business rules 1821-1 1821-n to determine whether such a function should be allowed or what the minimum purchase amount can be. This is one implementation of business rules; many more are possible at the discretion of the service provider. The service definition is obtained from service provider database 1822 and is used to determine who the actual provider of the service is and how connectivity can be established. In this case, the provider is a mutual fund purchasing gateway where the connection is a secure TCP/IP socket carrying a proprietary set of name/value pairs to execute the transaction 1823. Once the gateway approves the transaction, it is forwarded to the fund manufacturer QWERTY over a private clearing and settlement system 1824. Presumably, the transaction will be reflected in the next statement generated by QWERTY.

Alternate embodiments can be defined where the subscriber is connected directly to the fund gateway or to the fund manufacturer itself. In each case, the provider uses its own business rules and operates without intervention by the service provider.

A key aspect of the present invention is to apply the method to various applications whose information management and delivery requirements are common. The entities and processes described above are intended to be generic with the intent that the actual application may extend the definitions to reflect the business requirements. The underlying definitions remain in place as well as the rules and processes defined by the present invention; however, the visual aspect of the model can be customized as needed. The tools that are provided by the model for this purpose are:

1. Extensible entity and process definitions.

2. Customizable user interfaces.

3. Business service customization.

4. Multi-language capability.

Two examples will demonstrate the presentment system and method in two particular applications.

The first example is an insurance application where premiums are paid quarterly and a copy of the policy is sent annually. This application would be implemented under the present application as follows:

The entity definitions are mapped to terms that are specific to the insurance industry:

Subscriber becomes policyholder.

Publisher becomes insurer.

Account number becomes policy number.

Document type report becomes policy.

Document type statement remains statement.

The user interfaces will automatically make use of the new terms due to the use of a dictionary; for example, subscriber is mapped to policyholder. A business service called payment is defined where the external provider is a gateway that supports credit, debit, and direct funds transfer. The service provider arranges a service contract with the gateway provider and makes the payment service available to the policyholders via a link in the statement similar to the one described in FIG. 13.

The insurance company defines templates that render statements in English, French, and Spanish using the process described in FIG. 16. The template is defined to generate the link to the payment service. The user interface dictionary also supports these three languages for the terms shown above. The system is installed on the insurer's existing computers along with the system that produces the insurer's quarterly statements. In this case, the insurer and the service provider are the same entity. The statements are produced as a single cycle and loaded onto the system as described by FIG. 15. Each statement has a unique invoice number generated by the insurer for reconciliation purposes. Furthermore, each policy has a unique number also generated by the insurer (the account number in the present invention). The insurer using an insert that is added to the quarterly statement promotes the new service. The policyholders are expected to self-register and activate their account at their own convenience at a defined Web site that is the service provider domain. In order to verify that the person requesting the activation is the actual policyholder, the insurer generates an 8-digit number that is unique to the policyholder and prints it on the current statement. The policies are added to the service provider domain as accounts along with the 8-digit number. The question asking for the number is added to the publisher profile in the three supported languages. When the policyholder decides to take advantage of the service, he/she first accesses the named Web site using a personal computer. Self-registration proceeds as described by FIG. 10, in which the policyholder selects a userid and password. The next step is to activate the existing account for electronic delivery, which proceeds as described by FIG. 12. The policyholder supplies his/her name and policy number and, at step 1230, answers the prompt for the 8-digit number that was included on the last mailed statement. If the supplied number matches the one that was associated with the account, then activation is complete. The policyholder can now view the loaded statements as described by FIG. 14 and initiate payment form the statement as described in FIG. 18.

The second example is a mutual fund company and that deals with institutional investors. The company has recently acquired a competitor. The desire is to offer a service whereby designated employees of the investors can view electronic statements from either company. The short term is to manage the two companies independently and integrate the acquired portfolios at a later date. Some investors deal with both companies while some deal with one or the other. In the short term, accounts, statements, and corporate branding will continue to reflect the two companies. In the long term, the acquired funds will simply be added to the acquirer's set of funds.

The entity definitions are mapped to terms that are specific to the mutual fund industry:

Subscriber becomes investor.

Publisher becomes fund manager.

Account number remains the same.

Document type statement remains the same.

The user interfaces will automatically make use of the new terms due to the use of a dictionary; for example, subscriber is mapped to investor. The systems that manage the business of the two companies will remain independent in the short term while a service provider domain will be constructed on a server system such as the one described in FIG. 2. The overall relationship is illustrated in FIG. 25. The acquiring fund company is known as XYZ Mutual Funds and, since the service provider is the same company, the service provider domain is called XYZ.MUTUAL.FUND 2500. The two fund companies are named XYZ 2510 and ABC 2520; these are defined as publishers within the present invention. Two typical subscribers are also shown as 2530-1 to 2530-n. When the two companies produce statements, they are loaded to the service provider using the process defined by FIG. 15. Also, one template is defined for each company, allowing the statement to be rendered in the existing format, including corporate branding. Since the investors are institutional, self-registration is not desired. The investors are defined as subscribers and their employees are defined as users tied to their respective subscriber organizations. The user identifiers and passwords are sent to the investors by courier or similar secure delivery. Investor employees access the service provider and are able to view statements from either company.

The requirements of the second phase of the acquisition are that all statements use one format, specifically that of the acquiring company. This must be done, however, without changing the acquired company's processing system and statement output. To do this, a new template is created that accepts the acquired company's data format but renders it to look like the acquiring company's statement. The effective date of the new template is set based on an agreed upon cutover date; any statements older than that date will be formatted using the older template. It is also possible at this point to create a consolidated statement where the information from two documents (one from each company) is rendered as one visual statement to the investor. This is an option within the present invention that is defined in FIG. 14 in steps 1420-1 to 1420-n.

As an alternative implementation, both of these applications can be deployed on a single hosted facility that is managed by an independent third party. If, at some future time, the insurer of mutual fund company decides to allow access to customers who use other service providers such as financial portals, this is accomplished by establishing a service provider partner relationship between these other providers and the service provider domains that are described above. The process for doing this is described in FIGS. 4 and 5.

Similar applications that are disclosed in other patents including, but not limited to B2C Electronic Bill Presentment and Payment, B2B Electronic Invoice Presentment and Payment, Electronic Statement Presentment, equity trade confirmations, and consolidated bank statements may be implemented by one skilled in the art on the same system that is disclosed in the present invention.

The invention provides the ability to define business models by establishing partner relationships among service providers. The variables that can be permuted to construct different deployment models are the enabled participant type(s), service provider partnerships, levels of trust, single/multiple of participant access, and location independence. A given service provider may be defined as subscriber-enabled, publisher-enabled, or both. Service provider partnerships are disclosed previously in the model. Level of trust is one aspect of a service provider partnership that defines how closely coupled the partnership is. In a trusted relationship, a request received from another service provider can be trusted. The authentication of the participants and the validity of the participant identity passed from the partner service provider would also be trustworthy. The connectivity between the service providers may be secured by a mutual authentication such as challenge/response or exchanged public/private keys, and by encrypting the data that flows between them. In the preferred embodiment, there is a trusted relationship between service providers, and alternate embodiments allow custom authentication such as single-signon to be developed. Service providers can be configured to support one participant or multiple. Specialized implementations tend to support one participant only whereas general implementations such as portals and consolidators likely support multiple participants. Location independence dictates that a service provider may be deployed on any hosted facility, shared or private, so long as it satisfies the basic infrastructure requirements that are disclosed in the present invention. For example, a service provider may be deployed on a publisher's existing computer system and reach all of its customers by establishing partnerships with one or more subscriber-enabled service providers.

The critical factor upon which the present invention is dependent is the widespread availability of network services and computer resources. The advent of the personal computer and the evolution of the Internet have satisfied these requirements.

FIG. 19 displays one of the basic models that can be built with a single service provider that is both subscriber- and publisher-enabled. It is known generically as a publisher direct model, meaning that one and only one publisher is defined while multiple subscribers can be defined, each of which access the publisher information directly. A service provider called ABCDEF.POWER 1900 is enabled for both publishers and subscribers. One publisher called ABCDEF 1910 is defined along with multiple subscribers 123456 1920-1 and 567890 1920-n. The preferred embodiment of the publisher direct model is where the service provider and publisher are one in the same. Alternate embodiments allow the service provider to be a different entity; for example, a hosted facility may operate many independent publisher direct service providers on behalf of the publishers.

Another related model that is not illustrated is the subscriber direct, where the service provider supports one subscriber only but multiple publishers. A manufacturer that deals with many suppliers may deploy such a model.

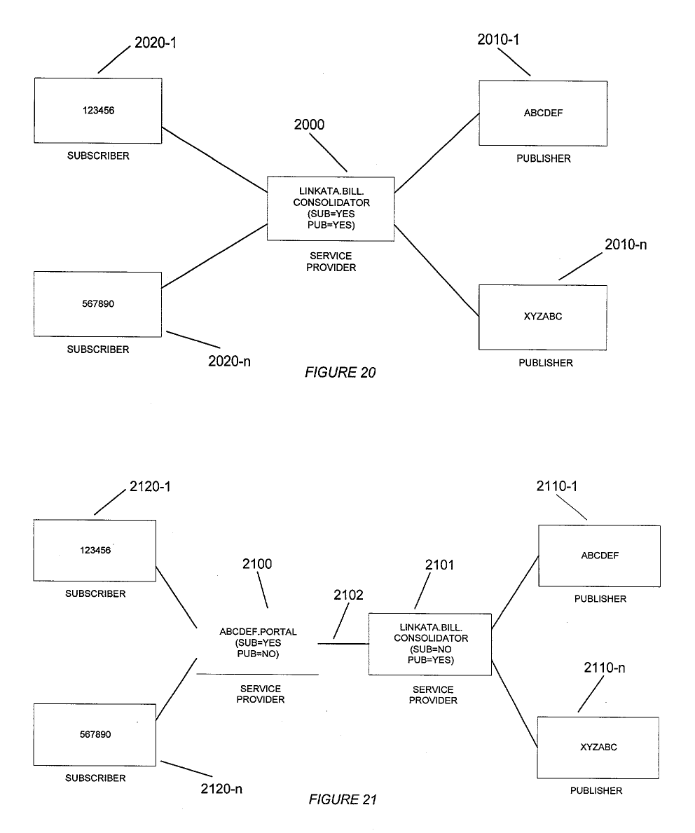

FIG. 20 displays another basic model that involves one service provider that is both subscriber- and publisher-enabled. It is known generically as a document consolidator model, meaning that its purpose is to consolidate documents from multiple publishers and make them available to multiple subscribers. One service provider called LINKATA.BILL.CONSOLIDATOR 2000 is enabled for both publishers and subscribers. Multiple publishers called ABCDEF 2010-1 and XYZABC 2010-n are defined along with multiple subscribers 123456 2020-1 and 567890 2020-n. The preferred embodiment of the document consolidator model is where the service provider is an independent entity. Alternate embodiments may allow several publishers to form a consortium where the publisher population is restricted.

FIG. 21 shows a more complex model where more than one service provider is involved. This is actually a merger of two more basic models. One service provider called ABCDEF.PORTAL 2100 is enabled for subscribers only and has registered the subscribers 123456 2120-1 and 567890 2120-n. Another service provider LINKATA.BILL.CONSOLIDATOR 2101 is enabled for publishers only and has registered the publishers ABCDEF 2110-1 and XYZABC 2110-n. The two service providers have defined a partner relationship 2102. The two basic models are the subscriber consolidator and the publisher consolidator. As the names imply, their purpose is to provider a consolidation point for subscribers and publishers, respectively.

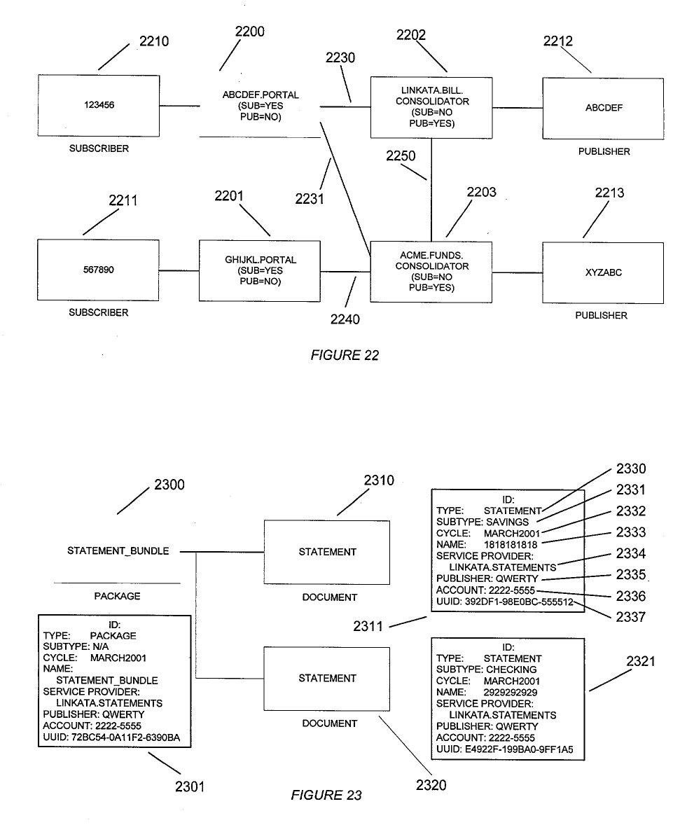

FIG. 22 shows a more complex deployment model that involves interaction among four service providers. There is no name for this model; its purpose is to illustrate one possible implementation under the present invention. Two service providers called ABCDEF.PORTAL 2200 and GHIJKL.PORTAL 2201 are enabled for subscribers only and have registered the subscribers 123456 2210 and 567890 2211, respectively. Two other service providers called LINKATA.BILL.CONSOLIDATOR 2202 and ACME.FUNDS.CONSOLIDATOR 2203 are enabled for publishers only and have registered the publishers ABCDEF 2212 and XYZABC 2213, respectively. Service provider ABCDEF.PORTAL has a partnership with both publisher-enabled service providers 2230 2231. Service provider GHIJKL.PORTAL has a relationship with ACME.FUNDS.CONSOLIDATOR only 2240. Thus, subscribers who are registered with ABCDEF.PORTAL can access documents from both publishers. Finally, the two publisher-enabled service providers have established a relationship 2250 for sharing information. This may be used to allow selected documents from LINKATA.BILL.CONSOLIDATOR to be copied over to ACME.FUNDS.CONSOLIDATOR in order to make them available to subscribers that are not registered with ABCDEF.PORTAL.

The four models discussed in FIGS. 19 through 22 are closed, meaning that the registered participants must access one of a limited number of eligible service providers. Open models, on the other hand, require that service providers allow quick and seamless definition of partnerships where the only purpose is supporting the choice of the involved participants. These models are much more complex and represent two of the primary goals of the present invention. The first is to allow subscribers and publishers the freedom to select the provider of information management and delivery strictly on the basis of business criteria such as cost and class of service. The second is to hide the complexity of the information exchange from publishers and subscribers by allowing them the option of selecting one service provider to fulfill all of their requirements rather than being forced to register with multiple providers simply to access all of their trading partners.

The foregoing is considered as illustrative only of the principles of the invention. Further, since numerous modifications and changes will readily occur to those skilled in the art, it is not desired to limit the invention to the exact construction and applications shown and described, and accordingly, all suitable modifications and equivalents may be resorted to, falling within the scope of the invention and the appended claims and their equivalents.

All publications, patents and patent applications are incorporated by reference in their entirety to the same extent as if each individual publication, patent or patent application was specifically and individually indicated to be incorporated by reference in its entirety.

What is claimed is:

1. A system for electronic document presentment over Internet by at least one generic publisher for at least one generic subscriber, comprising:
(a) an interface for receiving financial information from a publisher for publication as a document, and for allowing access to the document by a subscriber, the subscriber being located remotely from the publisher in communication over the Internet;
(b) a processor in communication with the interface, running software for publishing the information in the document and selectively allowing retrieval of the document by the subscriber; and
(c) a computer storage for storing the information responsive to the interface and the processor,
the software categorizing the subscriber and associating the subscriber with a security term, the security term determining the degree of access and interactivity with the information in the document, the degree of access and interactivity being determined by the categorization of the subscriber's relationship to the information.

2. The system of claim 1, wherein the software further comprises a loader for receiving information from each said publisher and publishing the information in the document in a format according to at least one template pre-defined by the publisher.

3. The system of claim 2, wherein the loader comprises a loader for automatically retrieving information from each said publisher on a pre-defined periodic basis.

4. The system of claim 2, wherein each said template includes one or more of: language-, format-, and date-sensitivity.

5. The system of claim 2, wherein the information comprises information in XML format.

6. The system of claim 2, wherein the template comprises an XSLT template.

7. The system of claim 2, wherein the loader further comprises an aggregator for grouping documents associated with a subscriber by aggregating multiple documents in a single package.

8. The system of claim 1, wherein the software further comprises a messenger for electronically notifying a subscriber of at least one document to be retrieved.

9. The system of claim 1, wherein the subscriber comprises an accountholder of the publisher.

10. The system of claim 1, wherein the subscriber comprises a representative of an accountholder of the publisher.

11. The system of claim 10, wherein the representative comprises a financial advisor to the accountholder.

12. The system of claim 1, wherein the document comprises a bill.

13. The system of claim 1, wherein the document comprises a statement.

14. The system of claim 1, wherein the document comprises an invoice.

15. The system of claim 1, wherein the document comprises a notice.

16. The system of claim 1, wherein the document comprises a report.

17. The system of claim 1, wherein the software comprises an authenticator for registering the subscriber and authenticating the identity of the subscriber before permitting the subscriber to access or interact with a document.

18. The system of claim 1, wherein the degree of access and interactivity comprises the ability of the subscriber to perform one or more of the following: viewing the document, printing the document, sending an electronic copy of the document, making an online payment relating to the information in the document, accessing an associated subscriber profile, submitting to the publisher an objection to the information in the document, communicating with the publisher in regard to the information in the document, downloading the information to a financial management software application, and accessing an electronic service supplied by the publisher or a third party using information contained in the document.

19. The system of claim 1, wherein the system comprises a system for electronic document presentment between one publisher and a plurality of subscribers.

20. The system of claim 1, wherein the system comprises a system for electronic document presentment between a plurality of publishers and one subscriber.

21. The system of claim 1, wherein the system comprises a system for electronic document presentment between a plurality of publishers and a plurality of subscribers, the system being managed by a service provider for mediating presentment between the publishers and the subscribers.

22. The system of claim 1, wherein the at least one publisher comprises a first publisher, a second publisher, and a consolidator, the consolidator consolidating the information from the first publisher and the second publisher to be published in a document.

23. An electronic document presentment method over the Internet for allowing a generic subscriber to access and interact with financial information supplied by at least one generic publisher, the information being published in the form of a document, the method comprising:
(a) receiving an electronic request from a subscriber to access a document over the Internet, the subscriber providing identifying details to describe the subscriber's relationship to the information in the document requested, the subscriber being associated with a security term;
(b) processing the identifying details to categorize the subscriber and the subscriber's relationship to the information in the document requested;
(c) selectively permitting the subscriber to access all or a part of the information in the document; and
(d) selectively permitting the subscriber to interact with all or a part of the information in the document,
the subscriber having a defined degree of access and interactivity with the information in the document based on the security term, the security term being determined by the subscriber's relationship to the information.

24. The method of claim 23, wherein the method further comprises loading information from the publisher and publishing the information in the document in a format according to at least one template pre-defined by the publisher.

25. The method of claim 24, wherein the method further comprises automatically loading information from the publisher on a pre-defined periodic basis.

26. The method of claim 24, wherein each said template includes one or more of: language-, format-, and date-sensitivity.

27. The method of claim 24, wherein the information comprises information in XML format.

28. The method of claim 24, wherein the template comprises an XSLT template.

29. The method of claim 24, wherein the method further comprises aggregating documents associated with a subscriber.

30. The method of claim 23, wherein the method further comprises electronically notifying a subscriber of at least one document to be retrieved.

31. The method of claim 23, wherein the subscriber comprises an accountholder of the publisher.

32. The method of claim 23, wherein the subscriber comprises a representative of an accountholder of the publisher.

33. The method of claim 32, wherein the representative comprises a financial advisor to the accountholder.

34. The method of claim 23, wherein the document comprises a bill.

35. The method of claim 23, wherein the document comprises a statement.

36. The method of claim 23, wherein the document comprises an invoice.

37. The method of claim 23, wherein the document comprises a notice.

38. The method of claim 23, wherein the document comprises a report.

39. The method of claim 23, wherein the subscriber is a registered subscriber, and step (a) of the method further comprises authenticating the identity of the subscriber according to a profile associated with the subscriber, before permitting the subscriber to access or interact with the document.

40. The method of claim 23, wherein, according to the degree of access and interactivity, step (d) further comprises allowing the subscriber to perform one or more of the following: viewing the document, printing the document, sending a copy of the document electronically, making an online payment in response to the information in the document, accessing an associated subscriber profile, submitting to the publisher an objection to the information in the document, communicating with the publisher in regard to the information in the document, downloading the information to a financial management software application, and accessing an electronic service supplied by the publisher or a third party using information obtained in the document.

41. The method of claim 23, wherein the system comprises a system for electronic document presentment between one publisher and a plurality of subscribers.

42. The system of claim 23, wherein the system comprises a system for electronic document presentment between a plurality of publishers and one subscriber.

43. The system of claim 23, wherein the system comprises a system for electronic document presentment between a plurality of publishers and a plurality of subscribers, the system being managed by a service provider for mediating presentment between the publishers and the subscribers.

44. The method of claim 23, wherein the at least one publisher comprises a first publisher, a second publisher, and a consolidator, the consolidator consolidating the information from the first publisher and the second publisher to be published in a document.
